(19) United States
(12) Patent Application Publication
(10) Pub. No.: US 2012/0018375 A1
(43) Pub. Date: Jan. 26, 2012

(54) METHOD AND DEVICE FOR RECYCLING CLEANING OR RINSING WATER, IN PARTICULAR RINSER WATER

(75) Inventors: Dirk Scheu, Amerdingen (DE); Florian Hackl, Lappersdorf (DE); Dirk Schlaipfer, Greven (DE)

(73) Assignee: KRONES AG, Neutraubling (DE)

(21) Appl. No.: 13/094,861

(22) Filed: Apr. 27, 2011

(30) Foreign Application Priority Data
May 3, 2010 (DE) 102010028487.4

(51) Int. Cl. C02F 1/44; B08B 13/00; C02F 9/04

(52) U.S. Cl. 210/638; 210/639; 134/109

(57) ABSTRACT

A method for recycling cleaning or rinsing water, in particular rinser water, as well as a corresponding device for carrying out the method, where, for reducing the amount of water, first filtering water with a reverse osmosis system, then providing the permeate with an additive acting in a sanitizing or disinfecting manner, to then use the permeate loaded with the additive as cleaning or rinsing water and at least join a portion of the used cleaning or rinsing water with the concentrate in a reverse osmosis system, and filtering the mixture then by means of the reverse osmosis system.

### CROSS-REFERENCE TO RELATED APPLICATION

The present application claims the benefit of priority of German Patent Application No. 102010028487.4 filed May 3, 2010. The entire text of the priority application is incorporated herein by reference in its entirety.

### FIELD OF THE DISCLOSURE

The disclosure relates to a method and a device for recycling cleaning or rinsing water, in particular rinser water.

### BACKGROUND

During cleaning or rinsing of food containers, in particular bottles, large amounts of waste water arise. In FIG. 4 (Prior Art), this is in particular described in connection with the rinsing of PET bottles or also glass bottles in cold aseptic filling. With the cold aseptic filling of microbiologically sensible beverages and products, one can achieve a long durability of the food without adding any food preservatives and without hot filling. In the process, the containers or bottles, respectively, are rinsed with a disinfection solution by a rinser for disinfection before they are filled. Subsequently, the sterilized bottle can be fed to a filler, filled and closed. For rinsing, raw water is first fed to a reverse osmosis system and desalted. The concentrate which is formed in reverse osmosis is rejected and fed to the sewer. The permeate is processed in a hygiene center where the permeate is mixed with a disinfectant and optionally with a tenside and finally supplied to the rinser. A portion of the rinser water used in the rinser is also fed to the sewer. Another portion is still used for disinfecting the closing caps and subsequently rejected in the sewer.

In this process, a large amount of waste water arises. A corresponding method is therefore very disadvantageous from an economical and an environmental point of view.

In bottle cleaning machines, too, large amounts of waste water arise which unnecessarily increase process costs.

### SUMMARY OF THE DISCLOSURE

Starting from this situation, one aspect underlying the present disclosure is to provide a method and a device for recycling cleaning or rinsing water, in particular rinser water, which essentially reduce the amount of waste water in a simple way.

So, in accordance with the disclosure, the arising flows of waste water from the rinser and from the reverse osmosis system are no longer rejected but collected and mixed in a certain ratio in the process. Here, the additive, e.g. an acidic additive in the form of a peracetic acid or its decomposition product acetic acid, can react with the salts contained in the concentrate of the reverse osmosis system, e.g. to form acetates. Thus, the additives can be brought into a form that can be separated off by membrane technology and be removed by a downstream reverse osmosis system. Thus, the used cleaning or rinsing water, e.g. rinser water, and also the concentrate, i.e. the saliferous water from reverse osmosis, are no longer lost but can be effectively reused. The result is a reduction in waste water of about 40 to 60%, compared to prior art.

For a simple process management, it is advantageous for the concentrate of the reverse osmosis system from step a), in which the water was filtered, to be joined with the used cleaning or rinsing water. In relatively large systems or several system sections, however, it is also possible that the concentrate of another reverse osmosis system is added to the used cleaning or rinsing water.

According to a preferred embodiment, the additive is an acidic additive.

So, the permeate which is obtained in step e) from the mixture in reverse osmosis is advantageously returned in a cycle and can be used again for cleaning or rinsing. This permeate can in this case be returned either before, during or after step b), i.e. before, during or after the permeate is mixed with the additive. This cycle results in a particularly advantageous process management as from the beginning, less raw water can be fed to the first reverse osmosis system in step a) and correspondingly less permeate must be generated as the remaining amount of permeate is obtained by the recovery of the used cleaning or rinsing water or the concentrate. Therefore, the reverse osmosis system can have correspondingly smaller dimensions. Raw water can be saved. This results in the advantage that a volume flow rate of liquid can be supplied to the device for rinsing or cleaning, i.e. the rinser, which is larger than the volume flow rate of raw water supplied to the system.

According to a preferred embodiment, the cleaning or rinsing water is rinser water for rinsing bottles, in particular PET bottles, in cold aseptic filling. Advantageously, the acidic additive then for example comprises a polycarboxylic acid or its derivatives, advantageously peracetic acid. Possible derivatives are well-known to the person skilled in the art and can he selected from corresponding process water additives, e.g. peroxy acid ester or dicarboxylic acid peroxides. The polycarboxylic acid, e.g. the peracetic acid, is present in a balance between acetic acid and hydrogen peroxide. By the addition of the concentrate, for example the acetic acid can then react to form an acetate. Thus, the peroxy acid, in particular peracetic acid, which could not even be removed with conventional water treatment methods, for example the reverse osmosis system, can be separated off by the subsequent reverse osmosis.

It is advantageous if in step b), i.e. when the concentrate and the used rinsing or cleaning water are joined, raw water is supplied in addition. By the additional addition of raw water, the acid can be further diluted in the cleaning or rinsing water, and in addition, losses in the process cycle can be compensated. By the addition of raw water to the mixture, a certain ratio of the amount of the concentrate from the first reverse osmosis system to the amount of the used cleaning or rinsing water can be adjusted.

According to a preferred embodiment, a portion of the used rinser water is mixed corresponding to step d) with the concentrate of a reverse osmosis system, and a further portion, that means e.g. the rest, is used for further disinfection, in particular for closing cap disinfection or bottle disinfection or external filler disinfection. Thus, the already used rinser water can be used e.g. for closing cap disinfection and only be rejected afterwards. Thus, only the water which is entrained during the rinsing of the bottles and the water for further disinfection, e.g. the closing cap disinfection, is lost.

According to a particularly preferred embodiment, the used cleaning or rinsing water, or else the mixture of these, is subjected to heterogeneous catalysis. Here, the solutions are catalyzed, for example, with silver, so that the decomposition reaction of the additive is essentially accelerated. By the catalyst, for example the decomposition of hydrogen peroxide can be clearly accelerated. As, for example, the peracetic acid is present in a balance with hydrogen peroxide and acetic acid and the reaction is subject to the law of mass action, by the catalytic decomposition of the hydrogen peroxide, the reaction goes towards acetic acid, so that the decomposition of peracetic acid and finally also the formation of acetate are accelerated. The catalytic method has the advantage that no additional chemicals (reducing agents) are consumed in the reaction. Solid catalysts can moreover be easily separated off.

The device according to the disclosure comprises a reverse osmosis system for filtering raw water. Furthermore, for example in a hygiene center, an apparatus for mixing the permeate generated in reverse osmosis is provided with the additive to thus generate rinsing or cleaning water. Furthermore, the device comprises a rinsing or cleaning apparatus for rinsing or cleaning food containers, in particular bottles. A collection container is provided in which at least a portion of the used rinsing or cleaning water as well as concentrate from reverse osmosis can be collected to thus bring e. g. the peracetic acid into a form which can be separated off by membrane technology. Finally, another reverse osmosis system is provided which filters the mixture from the collection container and thus produces permeate which can be used again for the rinsing or cleaning apparatus.

For this, the system has a return line for returning the permeate from the reverse osmosis system.

According to a preferred embodiment, the device also has a reactor for heterogeneous catalysis which is arranged such that the used cleaning or rinsing water, or else first the mixture of the used cleaning or rinsing water and the concentrate, can be subjected to heterogeneous catalysis. If the mixture is subjected to heterogeneous catalysis, the reactor can also comprise the collection container. The reactor can also be arranged downstream of the collection container.

According to a preferred embodiment, the rinsing or cleaning apparatus is a rinser for rinsing bottles in cold aseptic filling. Advantageously, such a rinser is then followed by another disinfection apparatus, in particular a closing cap disinfection apparatus or an external bottle disinfection apparatus or an external filler disinfection apparatus which disinfects the closing caps or the bottles' outer surfaces or the fillers' outer surfaces with a portion of the rinser water used in the rinser.

Furthermore, the device comprises a supply line via which raw water can be supplied to the collection container.

Finally, the device advantageously comprises a permeate storage into which the permeate can be returned via the return line. Advantageously, the permeate from reverse osmosis can also be introduced into this permeate storage for desalting raw water.

### BRIEF DESCRIPTION OF THE DRAWINGS

The disclosure will be illustrated below in greater detail with reference to the following figures.

FIG. 1 schematically shows the structure of a device according to a first embodiment of the present disclosure.

FIG. 2 schematically shows the structure of a second embodiment according to the present disclosure.

FIG. 3 schematically shows the structure of a third embodiment of the present disclosure.

FIG. 4 schematically shows the prior art.

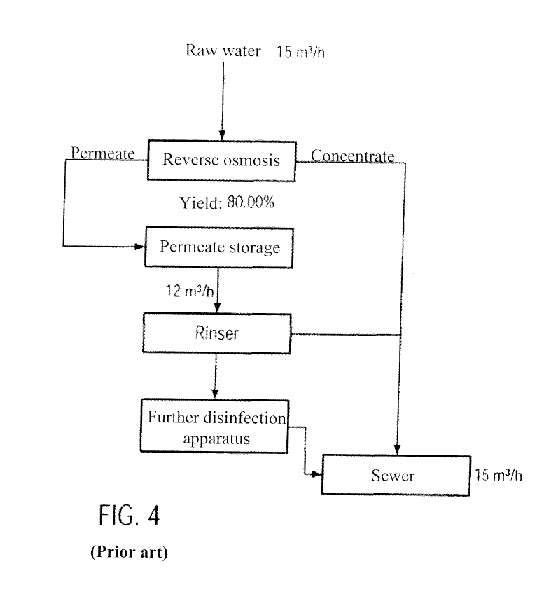

### DETAILED DESCRIPTION OF THE PREFERRED EMBODIMENT

The present disclosure will be described in particular in connection with the rinsing of bottles (PET bottles) in cold aseptic filling. With the cold aseptic filling of microbiologically sensible beverage products, one can achieve a long durability of the food without adding any food preservatives and without hot filling. In the process, the containers or bottles, respectively, which are transported in an unclosed state, are rinsed with a disinfection solution by a rinser for disinfection, i.e. their surfaces are washed off. Subsequently, the sterilized bottle can be fed to a filler, filled and closed.

The device comprises a raw water supply 6 via which raw water, e.g. tap water, can be supplied. Furthermore, the device comprises a reverse osmosis system 1 by means of which the raw water is filtered or desalted, respectively, so that the conductivity of the water is preferably less than 10 μS/cm. The reverse osmosis system is connected with a hygiene center 10 via a line 9 in which disinfectant, for example in the form of an acidic additive, and optionally also tenside, is added in proportion to quantity to the permeate P1 from the reverse osmosis system 1. It is also possible to use anon-acidic sanitizing additive. The following embodiment, however, will be described with an acidic additive. The hygiene center 10 can comprise a permeate storage 11 in which the permeate can be stored intermediately. From the hygiene center 10 or the permeate storage 11, respectively, the thus produced cleaning or rinsing water, here rinser water, can be supplied to a rinsing or cleaning apparatus 2, here the rinser 2, for rinsing food containers, here in particular PET bottles.

The rinser 2 can be part of a bottling plant which moreover comprises a filler and a closer. Though it is not represented here, the sterilized container or the sterilized bottle can be supplied to the filler and filled via a suited transport means. In the closer, the container is then closed by applying closing caps which have been disinfected beforehand. For this, the device advantageously has another disinfection apparatus, e.g. in the form of a closing cap disinfection apparatus 3, which applies rinser water used in the rinser 2 to the closing caps. The used rinser water from the disinfection apparatus 3 can be supplied to a sewer 4 via a line 18. It is also possible that the disinfection apparatus is present in the form of an apparatus for external bottle disinfection or for external filler disinfection.

Furthermore, a line 12 is provided via which concentrate (saliferous solution) can be fed from the reverse osmosis system 1 to a collection container 5. Used rinser water can also be supplied to the collection container 5 via a line 13. A line 19 leads from the collection container to a further reverse osmosis system 7 via which the mixture from the collection container 5 can be filtered. Concentrate K2 can be supplied to the sewer 4 via a line 15. The permeate P2 from the reverse osmosis system 7 can then be returned via a return line 8 to be used again for the rinser 2. Here, the return line 8 can supply the permeate P2 to the permeate P1 either upstream of the apparatus 10 for mixing the permeate with an acidic additive, e.g. into the line 9, or else afterwards into the line section 17, or else in this apparatus 10, 11, for example in the permeate storage 11. It is essential that the permeate P2 is returned in such a manner that it can be employed again as disinfectant in the rinser 2.

Furthermore, the device comprises a line 14 via which raw water from the raw water supply 6 can be fed to the collection container 5.

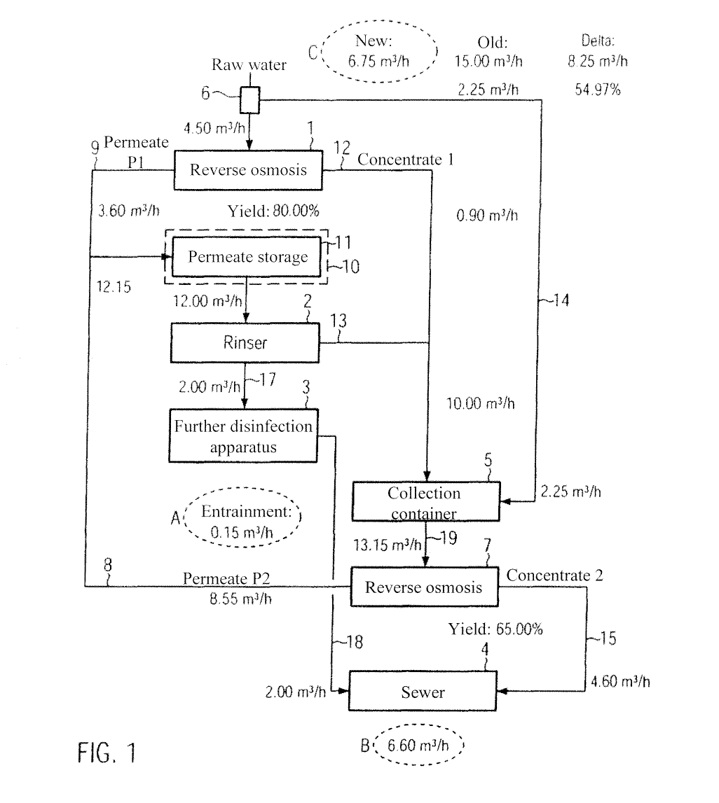

The present method will be illustrated more in detail below with reference to FIG. 1.

First, raw water from the raw water supply 6 is supplied to a reverse osmosis system 1 with a certain volume flow rate, e.g. 4.5 m³/hour. The raw water which is supplied to the reverse osmosis system 1, however, is only a portion of the amount of raw water that is altogether required for rinsing. The difference between the amount of water supplied to the reverse osmosis system 1 and the amount of Water C required altogether is supplied to the system via the line 14 (i.e. via the collection container 5), as will be illustrated below more in detail.

So, the total amount of raw water C which is required for the cleaning or rinsing process is composed of raw water which is supplied to the reverse osmosis system and raw water which is supplied to the mixture of used cleaning or rinsing water and concentrate.

In this concrete embodiment, 2.25 m³/h of raw water are supplied to the collection container 5, so that a total amount of supplied raw water of 6.75 m³/h results. In prior art, 15 m911 had to be supplied for a comparable process, so that a difference of 8.25 m³/h results. This results in a saving of 54.97%.

The raw water is filtered or desalted, respectively, in the reverse osmosis system 1, so that the conductivity is preferably smaller than 10 μS/cm². The yield here is between 75% and 85%, i.e. 15-25% of the raw water become concentrate. The permeate P1 is supplied to the hygiene center 10 via the line 9 to be mixed there with disinfectant. The Volume flow rate of the permeate P1 is here 3.6 m³/h.

In this embodiment, the permeate P1 is supplied to a permeate storage 11. Disinfectant is supplied to the permeate P1 in proportion to quantity, and optionally tenside is also supplied. As a tenside, for example a non-ionic one is suited. The tenside concentration can be within a range of up to 1000 ppm.

For rinsing bottles, peracetic acid is particularly suited as disinfectant. As can be taken from the following equation 1, peracetic acid (PES) is present in a balance between acetic acid and hydrogen peroxide (WPO).

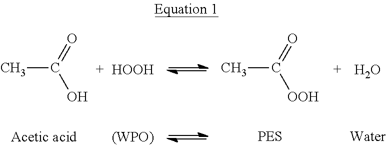

Balance peracetic acid is commercially available in concentrations between 2.5% and 40%. As to the quantity, for example 500 to 3000 ppm of peraectic acid are added to the permeate P1 per liter.

To generate the cleaning or rinsing solution, the permeate P2 is additionally supplied via the line 8, where the permeate P2 is obtained as will be described later. The acidic additive, here the peracetic acid, is added to the permeate P2 either together with the permeate P1 or separately. It is also possible to supply the permeate P2 to the permeate P1 to which the acidic additive, here the peracetic acid, has been already added, so that then the desired concentration is adjusted.

This example is described in connection with peracetic acid. Equally, however, other peroxy acids and derivatives are also suited. Possible derivatives are well-known to the person skilled in the art and can be selected from corresponding process water additives, e.g. peroxy acid ester or dicarboxylic acid peroxides.

The finished rinser water is then supplied to the rinser 2. In the rinser 2, the food containers or bottles, respectively, are wetted, i.e. rinsed, with the rinser water from inside and outside, and thus sterilized. As was already described, the sterilized bottles are then transported to a filler.

An amount of rinser water of 12 m³/h is supplied to the rinser 2. The used rinser water is collected and at least a portion of it, e.g. 10 m³/h, is supplied to the collection container 5 via the line 13. The concentrate from the reverse osmosis system 1 is supplied to the collection container 5 via the line 12, here with a volume flow rate of 0.9 m³/h. The mixing ratio of the amount of concentrate to the amount of rinsing and cleaning water is here, for example within a range of 1 to 10 for the present case, depending on the raw water composition. Correspondingly, raw water is additionally conducted via the line 14 into the collection container 5. Here, the volume flow rate of the raw water is 2.25 m³/hour.

The initial process conditions are adjusted such that the filling level in the collection container 5 rises up to a certain level, so that a certain residence time, e.g. 30 to 120 min, in the collection container 5 results to permit a reaction of the acidic additive with the salt in the concentrate. So, in the collection container, the peracetic acid or the acetic acid can react with the salts of the concentrate K1 to form acetates which can be separated off by membrane technology. Salts in the concentrate are, for example, calcium acetate or calcium hydrogencarbonate. The salt concentration in the concentrate is about 6 to 8 fold of that of the raw water.

The mixture is then supplied to another reverse osmosis system 7, here with a volume flow rate of 13.15 m³/hour. As the peracetic acid has been brought into a separable form now, it can be filtered off by the reverse osmosis system, where the concentrate K2 is then supplied to the sewer 4 via the line 15, here with a volume flow rate of 4.6 m³/hour. The yield of the reverse osmosis is here within a range of 60%-70%, that means that 30-40% of the liquid to be filtered are discharged as concentrate.

The remaining rinser water used by the rinser is e.g. used for the closing cap disinfection, where here 2 m³/h are supplied to the closing cap disinfection. The rinser water 20 used in the closing cap disinfection apparatus 3 is then also lead to the sewer 4 with a volume flow rate of 2 m³/h. The rest of the rinser water can also be supplied, instead of to the closing cap disinfection, also to another disinfection apparatus 3 and then rejected. Thus, a total amount B of 6.6 m³/h is lead to the sewer. During the rinsing of the bottles or the disinfection of closing caps, an entrainment A of 0.15 m³/h results. The sum of the entrainment and the amount of waste water which was lead to the sewer corresponds to the supplied amount of raw water. A+D=C.

The permeate P2 from the reverse osmosis system 17 is here returned again for rinsing via the line 8 with a volume flow rate of 8.55 m³/h, as described above. Thus, a total permeate flow of 12.15 m³/h which is supplied to the permeate storage 11 results.

This results in the advantage that a larger volume flow rate of liquid can be supplied to the device for washing or cleaning, i.e. in the rinser 2, than the raw water supplied to the system.

The tensides are also separated off via the reverse osmosis system 7.

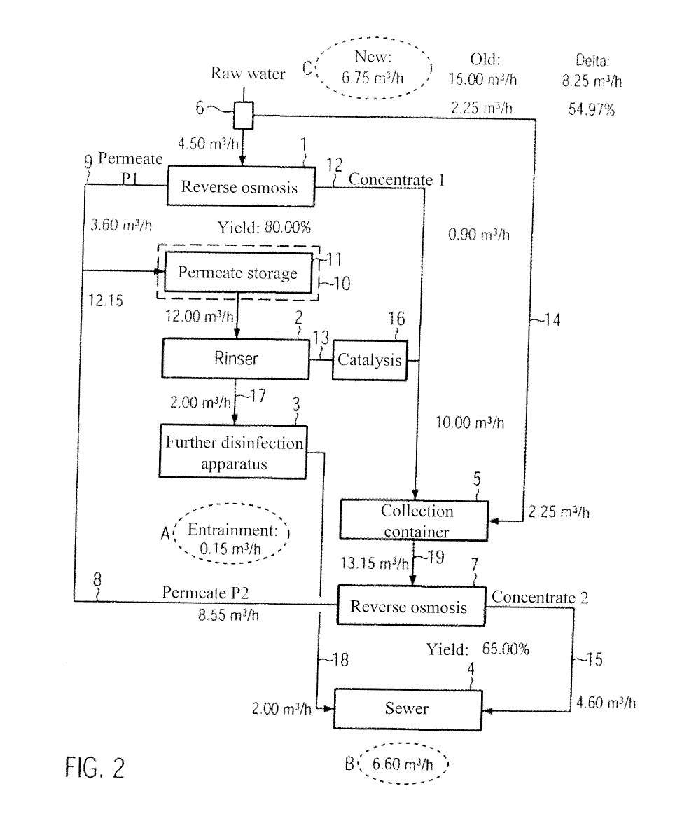

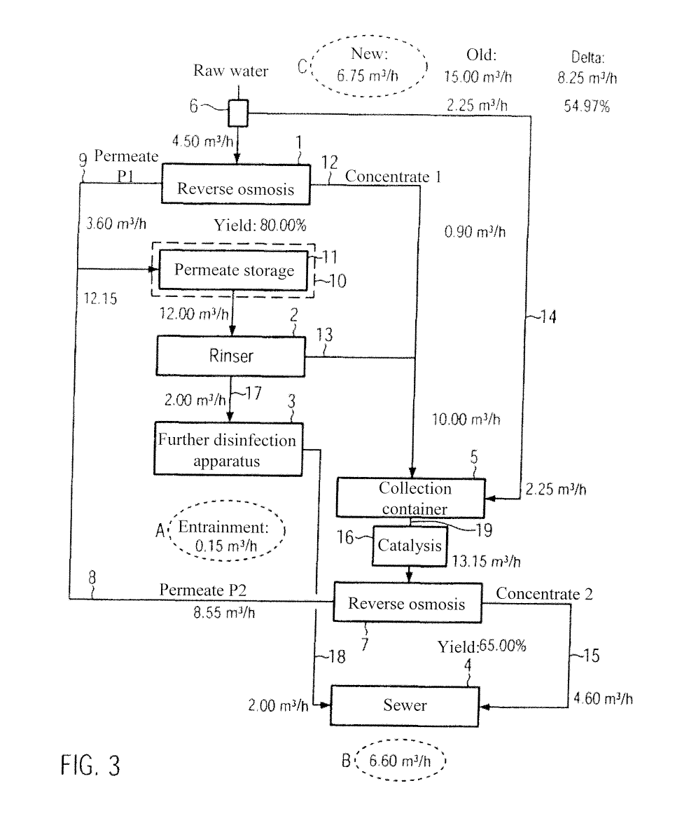

FIGS. 2 and 3 show another embodiment of the present disclosure. These embodiments correspond to the embodiment shown in FIG. 1, with the exception that in addition a reactor 16 for heterogeneous catalysis is provided. The reactor for heterogeneous catalysis 16 can be provided in the line 13 as shown in FIG. 2, so that the used cleaning or rinsing water can be subjected to the heterogeneous catalysis. As is shown in FIG. 3, the reactor for heterogeneous catalysis 16 can also be disposed such that the mixture of the used cleaning or rinsing water and the concentrate can be subjected to heterogeneous catalysis. It is also possible that the reactor 16 comprises the collection container (not represented). A reactor e.g. comprises a reaction vessel, at least one supply line for the reaction solution and at least one discharge line. Here, catalysis is carried out with a fixed catalyst. Thus, the catalyst separation required after the reaction can be facilitated or omitted, if e.g. a fixed bed reactor is employed. For example, silver is suited as heterogeneous catalyst. Silver having a large surface (for example granular material) can quickly decompose the polycarboxylic acid or derivatives thereof, advantageously peracetic acid. As can be taken from the following equations 2 and 3, the peracetic acid is subject to a temperature-dependent decomposition reaction.

2C₂H₄O₃→2C₂H₄O₂+O₂ Equation 2

2H₂O₂→2H₂O+O₂ Equation 3.

Decomposition can be accelerated by employing a catalyst. Peracetic acid is, as can be taken from equation 1, a reaction product of acetic acid and hydrogen peroxide. The reaction is subject to the law of mass action. By the catalytic decomposition of the hydrogen peroxide, the reaction runs towards the left. The catalytic process has the advantage that no additional chemicals are consumed in the reaction. By employing the reactor for the heterogeneous catalysis, the reaction to a form separable by membrane technology can be accelerated as acetates are formed more quickly together with the concentrate. Furthermore, the complete decomposition of hydrogen peroxide to water and oxygen is also accelerated. The residence time in the reactor can be e.g. 1 to 300 sec.

In the embodiments shown in FIGS. 2 and 3, the corresponding solution is catalyzed with highly pure granulated silver.

The disclosure was described in connection with a rinser as rinsing or cleaning apparatus. However, the disclosure, that is the joining of concentrate from a reverse osmosis system with a sanitizing or disinfecting agent, in particular with cleaning or rinsing waste water loaded with acidic, preferably organic acids, is also suited for other rinsing and cleaning apparatuses which are then arranged instead of the rinser 2. This means that the present disclosure is equally suited for rinsing and cleaning food containers or bottles, for example in bottle cleaners, etc.

1. Method of recycling cleaning or rinsing water, in particular rinser water, comprising the following steps:
a) filtering water by means of a reverse osmosis system,
b) mixing the permeate generated in step a) with an additive acting in a sanitizing or disinfecting manner,
c) using the permeate loaded with the additive as cleaning or rinsing water,
d) joining at least a portion of the used cleaning or rinsing water and the concentrate of a reverse osmosis system, and
e) filtering the mixture generated in d) by means of a reverse osmosis system.

2. Method according to claim 1, wherein the additive is an acidic additive.

3. Method according to claim 1, wherein the permeate which is obtained in step e) in the reverse osmosis is returned in the cycle one of before, during or after step b) and reused for cleaning or rinsing.

4. Method according to claim 1, wherein in step c), the cleaning or rinsing water is rinser water for rinsing bottles in cold aseptic filling, and the acidic additive added in step b) comprises a polycarboxylic acid or derivatives thereof.

5. Method according to claim 1, wherein in step d), additionally supplying raw water.

6. Method according to at least claim 4, wherein after rinsing, mixing one portion of the used rinser water corresponding to step d) with the concentrate of a reverse osmosis system, while using another portion of the used rinser water corresponding to step d) for further disinfection.

7. Method according to a claim 1, and subjecting the used cleaning or rinsing water or the mixture of the used cleaning or rinsing water to heterogeneous catalysis.

8. Device for performing the method according to claim 1 comprising:
a reverse osmosis system for filtering raw water,
an apparatus for mixing the permeate generated in the reverse osmosis system with an additive acting in a sanitizing or disinfecting manner for generating rinsing or cleaning water,
a rinsing or cleaning apparatus for rinsing or cleaning food containers,
a collection container for receiving at least a portion of the used rinsing or cleaning water and concentrate from the reverse osmosis system, and
a reverse osmosis system for filtering the mixture from the collection container.

9. Device according to claim 8, and further comprising a return line for returning the permeate from the reverse osmosis system, such that the permeate can be reused for rinsing or cleaning the food container.

10. Device according to claim 8, further comprising a reactor for heterogeneous catalysis which is arranged such that the used cleaning or rinsing water or the mixture of the used cleaning or rinsing water and the concentrate can be subjected to heterogeneous catalysis.

11. Device according to claim 8, and wherein the rinsing or cleaning apparatus is a rinser for rinsing bottles in cold aseptic tilling.

12. Device a least according to claim 11, and further comprising another disinfection apparatus which operates with a portion of the rinser water used in the rinser.

13. Device at least according to claim 8, further comprising a supply line via which raw water can be supplied to the collection container.

14. Device at least according to claim 8, further comprising a permeate storage into which the permeate can be returned via the return line.

15. Method according to claim 4, wherein the acidic additive added in step b) comprises peracetic acid.

16. Method according to claim 6, wherein the further disinfection comprises closing cap disinfection, external bottle disinfection or external filler disinfection.

17. Device according to claim 8, wherein the food containers are bottles,

18. Device according to claim 12, wherein the another disinfection apparatus is a closing cap disinfection apparatus, an external bottle disinfection apparatus, or an external filler disinfection apparatus.
